(19) United States
(12) Patent Application Publication
(10) Pub. No.: US 2024/0020415 A1
(43) Pub. Date: Jan. 18, 2024

(54) METHOD OF ANONYMIZING A MULTI-RELATIONAL DATASET

(71) Applicant: KONINKLIJKE PHILIPS N.V., EINDHOVEN (NL)

(72) Inventor: Fengchang Zhang, Shanghai (CN)

(21) Appl. No.: 18/221,716

(22) Filed: Jul. 13, 2023

(30) Foreign Application Priority Data
Jul. 14, 2022 (WO) PCT/CN2022/105731

(51) Int. Cl. G06F 21/62

(52) U.S. Cl. CPC G06F 21/6254

(57) ABSTRACT

A computing system (SYS) and related method for anonymizing a multi-relational dataset. The system may comprise an interface (IN) for receiving a data table of the multi-relational dataset. An analyzer (AZ) of computing system (SYS) analyzes the data table to obtain a result describing one or more characteristics of the data table. A selector (SL) of computing system (SYS) selects, based on the result, a privacy model (PM) for the data table from plural privacy models (PMj). An anonymizer (TAY) of computing system (SYS) applies a first anonymizing operation to the data table, based on the selected privacy model to obtain an anonymized data table.

### CROSS-REFERENCE TO PRIOR APPLICATION

This application claims the benefit of Chinese Application No. PCT/CN2022/105731, filed Jul. 14, 2022, which is hereby incorporated by reference herein.

### FIELD OF THE INVENTION

The invention relates to a computing system for anonymizing data in a multi-relational dataset, to a related method, and to a computer program product.

### BACKGROUND OF THE INVENTION

Datasets, such as of the medical kind, may be held in medical databases or other data storage means. Such datasets may relate to patients, their health records, medical history, etc. Datasets are valuable resources it has been found. Such datasets can be used in numerous applications. Examples include training machine learning models for medical applications, drug discovery, or medial data analytics to find new patterns and gain new insights. Each of these uses may improve healthcare. However, using such datasets may pose risks from a patient point of view as patient data, including confidential data, may be leaked with undesirable consequences.

Data anonymization has been proposed to address data leakage concerns. In data anonymization, original data in the dataset is replaced at least in parts by certain other data that is deemed safe enough for release as such replacement data reduces the risk for an individual patient being identifiable. Data anonymization may include removing some original data. However, it has been found that some current anonymization approaches may produce anonymized data of low quality and/or at a low safety level.

In particular, anonymization of a multi-relational dataset is underexplored. For example, anonymizing such a multi-relational dataset may require dealing with relational attributes and transactional attributes at the same time. This data structure inhomogeneity across data tables in multi-relational datasets appears to be unrecognized.

### SUMMARY OF THE INVENTION

There may therefore be a need for improved data anonymization.

An object of the present invention is achieved by the subject matter of the independent claims where further embodiments are incorporated in the dependent claims. It should be noted that the following described aspect of the invention equally applies to the related method, and to the computer program product.

According to a first aspect of the invention there is provided a computing system for anonymizing data a multi-relational dataset, comprising:
an input interface configured to receive at least one data table of the multi-relational dataset;
an analyzer configured to analyze the at least one data table to obtain a result describing one or more characteristics of the at least one data table;
a selector configured to select, based on the result, a privacy model for the at least one data table from plural privacy models; and an anonymizer configured to apply a first anonymizing operation to the at least one data table based on the selected privacy model to obtain at least one anonymized data table.

The at least one anonymized table is an anonymized version of the initial data table as received. Preferably, plural, such as all, data tables of the initial data set are so anonymized to obtain an anonymized version of the initial dataset. The so anonymized dataset may then be used by a data consumer to perform a number of different tasks, such as training a machine learning model, data mining or analytics, etc.

Preferably, the input interface is further configured to receive additional data, and the analyzer to further analyze the additional data to obtain the result.

In embodiments, the additional data may include external data associated with the at least one data table, wherein the external data is external to the dataset, and representative of a data consumer's background knowledge. The analyzer is further configured to analyze the external data and, optionally, at least one data consumer's profile, to obtain information that describe background knowledge of the at least one data consumer for the at least one data table. The result may be based on the information and on the at least one data table. The selector is further configured to select, based on the result, the privacy model for the at least one data table from the plural privacy models.

Thus, the privacy model may be determined based on dataset characteristics and attacker's background knowledge for yet better security against data leakage. Attacker's background knowledge is data including relations that the attacker (such as the intended data consumer) may be aware of. A profile is additional information about the attacker that may be used to relax or otherwise modify the attacker's background knowledge.

In embodiments, the system comprises a user interface (UI) configured to allow a user to vary type and/or amount of the external data, the analyzer, in response to such variation providing different results thus causing the system to provide different versions of the at least one anonymized data table. This UI-feature allows user reviewing of aspects of relaxing or tightening the privacy model protection mechanism or attacker's background knowledge. The user can thus study, preferably in real-time, what different background knowledge does to the anonymization.

In embodiments the first anonymizing operation is configurable to act on plural records of the at least one data table.

In embodiments the first anonymizing operation is configurable to make a record of the at least one data table inaccessible to a dataset query. The first anonymization operation may include suppressing one or more rows/records of the data table.

In embodiments the anonymizer is further configured to apply a second anonymizing operation to one or more data fields of the at least one anonymized data table, based on a pre-defined set of data-field level anonymization rules.

The second anonymizing operation may be configured as an optional per data field anonymization preferably done after the first anonymization operation. The second anonymizing operation may be based on a “blacklist” of designated data fields, not necessarily based on a privacy model. The second anonymizing operation may be based on data type. The data-field level anonymization may include hashing, removing, adding noise, etc.

In embodiments the second anonymizing operation is configurable to make a data-field of the at least one data table inaccessible to a dataset query.

The query may originate from a data consumer, an entity not owning the dataset and wishing to consume data. The original dataset is owned by publisher or is authorized by owner publish. Data consumer may be malicious, so data consumer may also be referred to herein as “attacker”.

In general, the first or second anonymizing operation may include one or more of suppression, obfuscation, generalization or any other suitable data modification operation. In embodiments, the result obtained by analyzer includes information that describe one or more properties of the at least one data table.

If additional data tables are used, the result may describe one or more characteristics of the data table and the additional data as a whole.

In embodiments the said information includes one or more statistical descriptors.

In embodiments the one or more statistical descriptors includes one or more quasi-identifiers, QIDs, of the at least one data table, or such QIDs may be derivable from such statistical descriptors.

In embodiments, plural data tables are anonymized based on their respective privacy model.

In embodiments, the plural privacy models are retrieved by the selector from a storage. For example, based on a similarity computing, a pre-defined privacy model may be reused. For example, the said results may be compared as to their similarity, and a previous privacy model may be reused to save CPU time.

The proposed system uses different privacy models, as opposed to a single such model for all or plural tables. This allows more accurately addressing privacy concerns. Thus, the proposed system selects different privacy models for tables that yield different results as provided by the analyzer. The system thus uses privacy model per table, rather than a single model for plural or all tables in the dataset.

Privacy concerns may arise because users may not want their data being used by third parties for example. Some legal frameworks drawn up by lawmakers such as the GDPR (general data protection regulation) are designed to safeguard privacy and need to be accounted for by data handlers.

The additional data, if received, is in addition to the at least one data table. The additional data may include the external data as mentioned above, and/or may include one or more data tables from the dataset. The additional data may be combinable with the at least one data table. Quasi-Identifiers may also be used in this combination. The analyzer may then be configured to analyze the at least one data table and the additional data in order to provide the result as one describing one or more characteristics of the at least one data table in combination with the additional data. This manner of analyzing the at least one data table and the additional data may facilitate global anonymization, as opposed to local anonymization where one, more than one or all tables are considered one at time separately, rather than in combination.

Thus, in the in the global anonymization approach, in addition or instead to using such an external dataset, other tables from the same dataset may be considered when processing herein a given table. Beyond the data structure of the given table, descriptors for the data structure of one or more other tables, such as the whole dataset, are considered, when selecting a (best fit) privacy model herein for a given data table. Optionally, the one or more other tables are considered in combination with the attacker's background knowledge.

Global anonymization approach is safer, whilst the local approach is quicker and uses less computing resources. Both approaches are envisaged herein in embodiments.

Optionally, further additional data, such as context information, may be incorporated to relax or enhance the selected privacy protection mechanism/privacy model. For example, the attacker's background knowledge may be relaxed.

The proposed system overcomes limitations of existing anonymizing approaches for multi-relational datasets. By using multiple privacy models as proposed herein, the system offers a better expressiveness over the use of a single privacy model in particular for a multi-relational dataset. The proposed system addresses the inhomogeneity and diversity of data structure or format as may be found in multi-relational tables, thus outperforming approaches that are based on a single privacy model.

The proposed system and method aim at alleviating disadvantages of current solutions of anonymizing multi-relational datasets. The proposed system is superior in terms of performance thanks to the proposed multi-privacy model approach, its per table approach where plural, preferably all tables, are analyzed, and each table has its own, “bespoke”, privacy model.

In another aspect there is provided a computer-implemented method for anonymizing data in a multi-relational dataset, comprising:
receiving at least one data table of the multi-relational dataset;
analyzing the at least one data table to obtain a result describing one or more characteristics of the at least one data table;
selecting, based on the result, a privacy model for the at least one data table from plural privacy models; and
applying a first anonymizing operation to the at least one table based on the selected privacy model to obtain at least one anonymized table.

In another aspect there is provided a computer program product comprising a computer readable medium, the computer readable medium having computer readable code embodied therein, the computer readable code being configured such that, on execution by a suitable computer or processor, the computer or processor is caused to perform the method as claimed in claim. In another aspect there is provided a use of the so anonymized data for any one or more of: i) training a machine learning model, ii) data mining, or any other use, preferably one that supports medical application or task.

“(Data) table” is part of a dataset that may be stored in a data storage. The table preferably represents structured data in the same dimension (same set of attributes) of data subjects. The dataset is said to be multi-relational if it includes multiple different data tables. Multiple tables are capable of expressing relations of multiple data dimensions for data subjects. Data subjects can be said or have multiple dimensions, and each dimension consists of multiple attributes or data fields. Attributes may be used interchangeably with data fields. Each attribute/data field may hold a data value. Data values of a particular dimension may be referred to as a datapoint or record. Such datapoint may describe a data subject (such as a patient). Datapoint may be represented as a point in a suitably dimensioned vector space. A proximity or distance function may be defined between datapoints. A data table may be stored or may be associated with a matrix structure having one or more rows and one or more columns. Plural rows and/or plural columns are common. Multiple rows may form a data table. A column represents a respective data-field across data subjects. A row may be referred to as a record. A record or row relates generally to data of a data subject. Alternatively, although less common, a record may be stored as columns and data fields in rows. One data table may be said to differ from another if it includes different data fields. A dataset as envisaged herein may be held in a database, such as relational database system, or in particular in a multi-relational database system, although other manners of storage and management are not excluded herein. The dataset may be stored or arranged as a collection of data files in any suitable format such as a text file, separator-structured data file (such as in csv (comma-separated-values), in spreadsheet format, etc. The dataset is preferably structured. If unstructured, the dataset may be converted into a structured format.

“(Single) dataset release” relates to plural, such as all, data tables in the dataset released together as a whole to a data consumer.

“Data subject” is a natural person (eg, patient) to whom the data in a record pertains.

“Datapoint” relates to an observation of a data subject, usually represented by a row/tuple in a data table.

“Attacker data consumer” relates to an entity to whom the dataset is released, either intended or not. Such entity is in general not the owner or publisher of the dataset.

“Direct identifier (ID)” are attributes that allow uniquely identifying a data subject or data point.

“Quasi-identifier (QID)” are one or more attributes that allow identifying a data point when taken together with attacker background knowledge or other QIDs, but do not allow uniquely identifying such data points on their own. Such identification via QID(s) may be unique, but this may not be so necessarily as a mere graded identification in terms of probabilities, or other scores, is also envisaged herein.

“Privacy model” is a set of requirements that allow objective quantification of a desired privacy level/leakage or de-identification risk. For example, the set of requirements can be integrated in a model to facilitate anonymization of a dataset. The privacy model controls the amount of information leakage that may be drawn from the held dataset. The privacy model may allow measuring privacy levels using functions or parameters. The privacy model may include criteria (such upper bounds etc) on acceptable/inacceptable data leakage/de-identification risk.

“Anonymizing (operation)/Anonymization” may include suppression of one or more records or individual one or more data field(s) a data table. Reversal (which is undesirable) of anonymization is called re-identification (“re-id”). Anonymization may include in general replacing the original data by replacement data. The replacement data may represent some property or the original data, but provides less information than the original data it replaces. Some statistical properties of the original dataset may thus be at least partly preserved in the anonymized data. Anonymization operation makes the original data inaccessible to a data consumer. Anonymization operation may avoid, or reduce the risk of, re-identification of a data subject. The risk corresponds to the privacy level as per the privacy model. Anonymization operation may include suppression of one or more records or suppression/modification of one or more individual data fields (parts of a record). Thus, an anonymization operation may be based, or act on, a record as a whole, or per data field. For example, in some privacy models, a group of records that are found to include matching quasi-identifier may be suppressed as a whole. An anonymizing operation may thus record/group-wise on the table or across multiple tables. Anonymization in respect of a data table may relate to applying a privacy model on the whole table. According to different privacy models, an outcome of which data is anonymized may be different. In general, anonymizing a table (that is, applying a privacy model in respect of the table) and anonymizing individual data fields are independent operations. In practice, the privacy model is applied first to the whole table. If a record attracts a lower score/probability as prescribed by the privacy model, such a record is deemed high risk and is subjected to anonymization operation. If needed, individual data fields may then be anonymized in a second step.

“High risk data subject” includes any data subject who belongs to a high-risk group as captured by a privacy model. Whether or not the data subject is high risk, can be established by comparing its leakage risk against a risk threshold. The leakage risk and threshold may be determined based on the privacy model used. The threshold may form an element, such as a parameter, of the privacy model. An example is parameter k in k-anonymity type models. Anonymization operations are applied to such high-risk data subject. Whilst anonymization may be done table by table, there is preferably a cross-table aspect. The reason is that when a high-risk subject is identified in one table, the consequential anonymization operation is preferably also applied in other one or more tables (of the dataset) in which this high-risk data subject is represented.

“k-anonymity” is an example of a specific privacy model, and a class of related privacy models. Such models may rely on the concept of QIDs, like, age, gender etc. k-anonymity modelling includes finding a group of records in the whole table, in which all the records share the same data value combination of the identified QIDs for this table. Such records may form an equivalence class in respect of this model. As per the k-anonymity model, as size of the equivalence class (EC) is established, eg., by counting the number of unique data subjects within each group/EC. Any group/EC with a size smaller than the predefined k-threshold of unique data subjects will be subjected to anonymization operation, such as suppression or generalization or other, as required. The k-threshold is a whole number and forms a parameter of the privacy model. k-anonymity model was described by L. Sweeney in “k-anonymity: a model for protecting privacy”, published in International Journal on Uncertainty, Fuzziness and Knowledge-based Systems, vol 10 (5), pp 557-570, (2002).

### BRIEF DESCRIPTION OF THE DRAWINGS

Exemplary embodiments of the invention will now be described with reference to the following drawings, which, unless stated otherwise, are not to scale, wherein:

FIG. 1 shows a block diagram of a computer implemented system for anonymizing a dataset;

FIG. 2 shows in more detail components of the system in FIG. 1; and

FIG. 3 shows a flow chart of a computer implemented method of anonymizing a dataset.

### DETAILED DESCRIPTION OF EMBODIMENTS

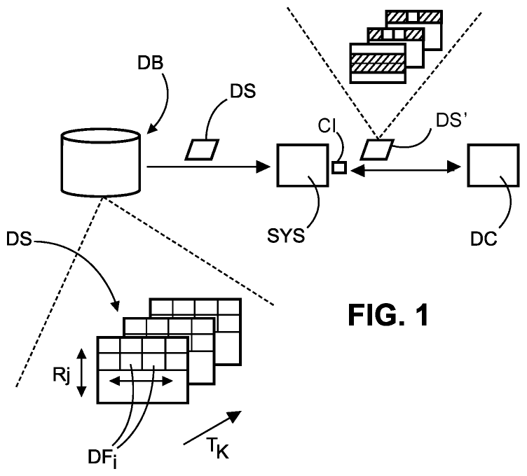

With reference to FIG. 1 there is shown a schematic block diagram of a computer implemented system SYS configured to anonymize or de-identify (both terms will be used interchangeably herein) an original dataset DS as may be held in one or more data storage systems, such as data base systems DB or the like.

The dataset DS to be processed for anonymization by system SYS may be a multi-relational data set, preferably held as multiple (data) tables Tₖ in a storage, such as a relational data base system, in particular, and in some embodiments, in a multi-relational database system.

Generally, anonymizing the dataset DS includes processing the dataset DS using one or more anonymization operations to effect such anonymization. The result of such processing is an anonymized version DS' of the original data set DS. Such anonymization allows avoiding that individual data subjects, whose data is represented in the dataset DS, can be identified by an interested party such as a data consumer DC, also referred to herein as an “attacker”. In general, data consumer DC is any party that wishes to process the dataset, but are not in general owners of the dataset DS.

In a medical setting as mainly envisaged herein, the dataset may relate to health records of various patients in one or more medical facilities, such as may be held in a hospital information system (HIS) or in a picture archiving and communication system (PACS). The dataset DS may include, for some or each patient, data items such as medical reports, image data, laboratory data, etc. In addition or instead, the dataset may include data items that relate to various bio-characteristics of individual patients, their respective health status, biographical data, biophysical data, and others. Some of this data may be of confidential nature (sensitive data). It is the anonymized dataset DS′, instead of the original data set DS, that may be released to data consumer DC. The anonymized dataset DS' safeguards patient's interest. Leakage of sensitive data, or of data that may allow identifying a given individual patient, is avoided, or is at least made less likely thanks to the released anonymized data DS′.

Whilst cryptographic processing is one way to protect data from leaking to unauthorized parties, in certain data consuming examples (one which more below), cryptography may not be useful as the data becomes unusable for data processing systems without prior decryption.

The system SYS address this problem by providing a tradeoff: system SYS is configured to apply anonymization operations to the original dataset DS to provide the anonymized dataset DS′. In this anonymized dataset DS′, certain aspects of the original data are protected, and yet the anonymized data is still of use to the data consumer DC. Specifically, the anonymizing operation as implemented by system SYS modifies the initial dataset DS in a manner to prevent, or make unlikely, that data subjects (eg, patients), to which the dataset DS relates, can be uniquely identified. At the same time, the applied anonymizations are such that statistical, collective information, such as statistical relationships, patterns etc, within in the original dataset DS are, to a sufficient degree, preserved in the anonymized/modified set DS. The anonymized/modified set DS' is hence still useful for data consuming tasks by the data consumer DC, for example of the sort to be outlined in the following. The anonymized dataset DS′, once released to data consumer DC, may reveal upon processing useful statistical information or insight in terms of useful patterns or useful relationships that can be used by the data consumer DC for certain medical task(s). A range of different data consuming tasks by data consumer DC (or other data consumers) may be envisaged in the medical field. One such data consuming task may include training a machine learning model based on the dataset. For example, the machine learning model may be trained for automatic diagnostics, such when classifying image data for presentation of a certain class of disease of interest. The dataset preferably relates to a large number of patients, and may include not only imagery (such as X-ray or of any other modality), but also contextual data. The dataset may thus facilitate robustness of the trained machine learning model. Other types of machine-learning applications envisaged herein may include training, based on the dataset DS′, a machine learning model to control a medical device such as an imaging apparatus, a contrast agent pump, a radiation delivery apparatus (eg, a linac), or any other medical device. Other data consuming applications of the dataset may include use in “virtual” drug discovery to discover suitable bio-markers, or for other medical analytics or medical data mining applications geared to find such patterns or relationships for a range of medical objectives. In sum, consumption of such medical patient dataset DS' could be used to facilitate or implement an efficient health care system, thus driving down costs, increasing patient throughput with less waiting times, and better quality, to the benefit of most.

The improved anonymization operations as afforded by the proposed system will be explained below at FIGS. 1-3 in more detail.

The dataset DS when modified by the anonymizer system SYS may be provided as a copy of the anonymized data DS' to the data consumer DC, either by transferring the dataset DS's via a communication channel to the consumer DC, or by other means, such as by granting remote access through a suitable query interface to the modified data DS′. No access however is provided to the original dataset DS. Such access schemes may be implemented in an off-line embodiment, where the anonymization by system SYS of the original dataset DS (which results in the modified dataset DS′) is done before a request for the data by consumer DC is received. The data consumer DC may not always be benign, but may wish to hack into the system by penetration. In such cases, it may be useful to ensure that only the modified dataset DS' may be accessible after such penetration.

Other embodiments, such as on-line embodiments, are also envisaged herein, where the data anonymizing system SYS is implemented as a middleware layer. The middleware layer may be arranged communicatively in-between a data base system that hosts the original dataset DS, and the access requesting party DC. For example, data consumer DC may issue through suitable query interface a search query to the data base to be applied to dataset DS. The search query is intercepted by a suitable communication interface CI of the system SYS, and the anonymizing operation is done in response to such a query. A suitably anonymized part of the dataset that respects the query may then then returned to the querying party, such as data consumer DC.

The system SYS may be implemented in one or more computing systems or units PU. For example, data anonymizing system SYS may be arranged in a Cloud or distributed architecture where functionalities of the system may be distributed among plural computing systems, suitably connected in a communication network. However, the system may also be implemented on a single computing system PU, if desired.

Referring now to the inset in FIG. 1 at the lower left, the original dataset DS may be stored in data storage DB. The original dataset DS may be stored or may be processable as the said plural tables Tₖ. Each table Tₖ is made up of plural records Rⱼ. A given records Rj may represent data of a respective data subject, such as a patient j. Each record Rⱼ in turn may be made up of plural data fields DF₁, each representing a certain attribute of data subject j. Each data field DF₁ may have a certain attribute value from an attribute domain stored. The attribute value represents an instant of the attribute for that patient j. For example, one data field may represent the age of a patient j, with a numeric value, such as a whole number, e.g. ‘45’, indicating that patient j is 45 years old, etc.

The said data tables Tₖ, including the records Rⱼ versus data fields DFᵢ structure, may be presented, stored, and/or processed as a respective indexed data structure, such as a matrix structure, whose rows and columns represents the respective table Tₖ. For example, records Rⱼ may be represented as rows, and data fields DFᵢ as columns of such a matrix structure. However, such an arrangement is just an example of convention, as rows may be represented instead as data fields, whilst records are in rows, as desired. However, representing records as rows is a common convention and will be used herein throughout, but, as said, this is not limiting. A data table is said to differ from other data table if one of the tables has a data field/attribute type that is not a data field of the other data table. In multi-relational dataset settings, different tables may be processed together, such by combination in a database join operation using some data field(s) as a common key, so that relations between two (or more) data tables can be represented.

Broadly, the anonymizer system SYS takes as input some or all of the original dataset DS, including the one or more data tables Tₖ, and produces, based on this input, the modified dataset DS' as output. Output of anonymization operation is illustrated as hatchings in the upper right-hand side of FIG. 1. For example, as a result of the anatomization operation, one or more rows and/or one or more distinct data fields (if not the whole row) in one or more data tables of the original dataset DS is made inaccessible to a third party, such as data consumer DC. Making data (that is, a row or distinct data field(s) on its own) in a data table inaccessible may include applying a data modification operation. Such modification may include deletion, obfuscation, suppression, generalization, and others. Such modification operation may relate to a given row as a whole, or to distinct data field(s), possibly with gaps. For example, for two or more suppressed rows there may remain one or more original data rows in-between, or for two or more suppressed data fields there may remain one or more original data fields in-between. For example, an entire one or more rows may be suppressed, or one or more data fields in a row are suppressed, with some original data field (s) remaining in that row. Modifications may include hashing the entire row or only certain distinct data field(s) therein. The original values may be substituted by certain symbols to obfuscate the original data values. Data values in a given one or more data fields may be shifted, by adding or subtracting certain values, such as noise, etc. Generalizing data values in a data field is another form of obfuscation. Generalizing data values may include substituting the respective data values with a large range or interval that includes the data to be anonymized. Any other manners of making data inaccessible are envisaged herein, the foregoing being examples which can be used either singly or in any (sub-)combination, as required.

The anonymization operation(s) is to protect original data. The original data in dataset DS is prevented from leakage to data consumer or other non-owner of the dataset, or likelihood for such leakage is reduced. This safeguards privacy of the data subjects whose data is in the dataset DS.

Anonymization is based on a privacy model PM=m. The privacy model m is a specification that describes the manner or other details of the level of privacy (or leakage protection) that is to be achieved by the anonymization operation(s). The privacy model m may be formulated as a set of conditions for elements in some suitable space, such as discrete space or continuous space. The elements may relate to data fields or rows. In one embodiment, the privacy model m can be implemented as a computing model to implement or represent the abovementioned specification and/or conditions. Applying the privacy model to the dataset DS to be anonymized may include solving an optimization problem in terms of an objective function to find the rows/data fields that need be anonymized to meet the conditions as per the privacy model. Graph-theoretical representation of the tables may be used, with discrete optimization procedures to find the fields and records that need to be anonymized. Applying the privacy model may be include computing a leakage or re-identification (“re-id”) risk per data row or data field. Those rows or data fields that attract a respective pre-defined risk level (for example, expressed by a score, such as p % or other) are then subject to anonymization, such as suppression, generalization, obfuscation, etc. Thresholding may be used to define the pre-defined risk level.

Thus, the privacy model m may allow quantifying the leakage risk per record in a given data table in terms of a score, such as a probability. Optionally and preferably, an overall leakage risk may be computed for the whole given table. This per table leakage risk may be computed based on the per record leakage risks. Some privacy models such as k-anonymity are based on QIDs, a special class of attributes that allow identifying a data subject when taken in combination. Equivalence classes among rows of a given table may be defined. Two records are in the same equivalence class if they share the same QID attribute values. Some privacy models, such as k-anonymity, specify that are at least k records to remain in each equivalence class. Thus, the re-id risk is 1/k. Other privacy models may specify other scores or probabilities to quantify the re-id risk per record. The scores may code differently for high risk, depending on convention. For example, a high score in terms of magnitude may indicate high or low id-risk, as the case may be.

Other privacy models envisaged herein include, in addition to the k-anonymity model mentioned above, KM-anonymity, t-closeness, etc. Some privacy models may be parameterized such as k, KM, or t in the above examples (note, parameter k in “k-anonymity” or on other privacy models is not related to generic index k of data tables Tₖ as used herein). A privacy model as understood herein differs from another when the conditions required by both differ. A privacy model may be conceptualized as made of model elements. A choice of different elements for a given model type may be considered herein as different privacy model instances.

Some privacy model elements may include one or more of: the given table, a selection of QIDs, and one or more model parameters. The model parameter(s) may facilitate defining the de-id risk in the framework of that model as illustrated above for the k-anonymity model. A change in either of these elements may be considered a different privacy model instance. For example, in case of the k-anonymity model type, this is specified for a given table in terms of QIDs for that table, and a value of parameter k. In practice, and in some embodiments, the k-value may remain the same across some or all tables in a particular case. However, the selection of QIDs may be different from table to table, thus giving rise to different privacy model instances. Thus, for the same table, given different QIDs, this may result in different privacy models at instance level.

Different privacy model instances, engendered by different model elements, may be considered in embodiments instances of the same model type herein. Selector SL may be configured to select different privacy model types. Thus, privacy model types may differ from one another up to parameterization. Preferably, parameterization is fixed, whilst the QID element may vary. In other embodiments, selector SL may select privacy model instances.

An effect of such privacy models, such as k-anonymity or others, may be understood in terms of query operations on the anonymized dataset DS′: data consumption by data consumer DC of anonymized dataset DS' may involve running a data mining operation, such as a search query, against the anonymized dataset DS′. The query may be implemented in SQL for example, or in any other query language, or any other data mining operation may be used. The query results in output which represents data that complies with the formulated query. Because of the anonymization applied to the dataset DS to obtain the modified dataset DS′, each or substantially most queries will result in output including plural data records Rj, so that no query will result in returning a single such record that may potentially allow uniquely identifying a data subject whose data includes the retrieved data points. The minimum number of hits returnable for each query, or the probability for this to happen, may be prescribed by the underlying privacy model. For example, in k-anonymity, the anonymization operations are so applied to the initial dataset that there always at least k records being returned, or at least that this is ensured in at least p % of cases, with p a confidentiality threshold that may be chosen suitably by user, such as p=95 for example. Such a confidentiality threshold may also be defined for privacy models other than k-anonymity.

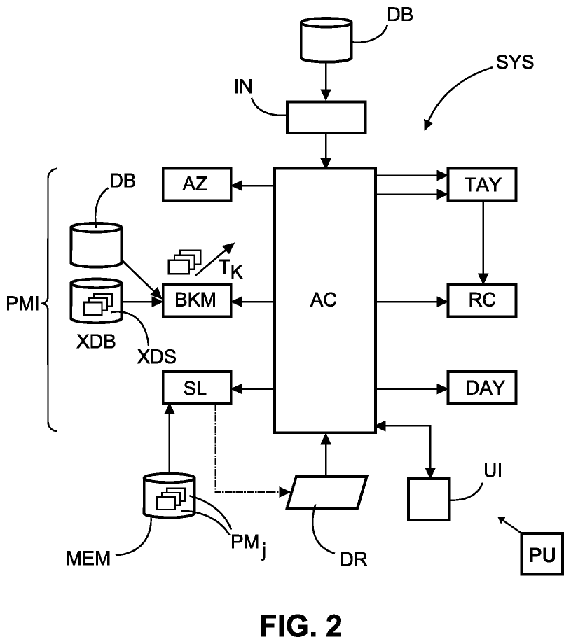

Operation of the data anonymizing system SYS is now explained in more detail with reference to the block diagram of FIG. 2. Broadly, the data anonymizer SYS as envisaged herein is configured for multi-privacy model application for improved, more accurate, bespoke, anonymization. The data anonymizer SYS takes characteristics of the given original dataset DS into account and chooses, from among different privacy models, one that fits the characteristics at a data table level for a given table. Thus, as proposed herein, the anonymizing system SYS uses plural privacy models PM for anonymization. Preferably, a suitable privacy model is selected per data table Tₖ from a pool of privacy models. The selected privacy model is bespoken to the given data table Tₖ to be processed by the anonymizing system SYS. Thus, instead of using a single privacy model for all or plural such tables, different privacy models PMₖ=mₖ may be used for different tables Tₖ, as required. This multi-privacy model approach allows more closely preserving statistical properties of the original dataset, whilst still protecting the privacy of the data subjects represented by the dataset DS. There is no need for overly modifying the data, thus potentially reducing its usefulness to data consumer DC. The proposed system SYS hence recognizes the “one size does not fit all” paradigm: with the proposed system SYS, data structure inhomogeneities across data tables in a given dataset DS is acknowledged and accounted for. That is, one table Tₖ may substantially differ in terms of their statistical characteristics, metrics, etc, from another table T_{k′}. For example, one table may include relational attribute(s) whilst another may include transactional attribute(s). Both may call for different pricy model to better balance the need for data protection on the hand, and on the other hand the desire for having undistorted data which is sufficiently faithful in terms of statistical properties compared to the original dataset.

Broadly, the system SYS may include three functional components PMI, TAY, DAY. The components include a privacy model identifier PMI that is configured to find, for each data table Tₖ, the respective, suitably fitting, privacy model PMₖ=mₖ.

The functional components configured for effecting the data anonymization operations according to the fitted privacy model mₖ may include a table anonymizer TAY. Optionally, there may be a data field anonymizer DAY.

The optional data field anonymizer DAY is configured to process the identified data field separately, by hatching or other modification, based on a pre-defined list of exclusions, as provided for example by a data security professional. The component DAY is optional herein and this operation can be done beforehand by excluding for example patient name and other information that is sensitive on its own or represents a (direct) identifier attribute. Thus, the dataset DS to be processed by system SYS may be assumed to be already sanitized by prior removal of sensitive data or direct identifiers.

In contrast to data field anonymizer DAY, the data table anonymizer TAY processes a given table as a whole, optionally using information from external data sources, such as from other tables in the same set DS, or from other datasets XDS external to the dataset DS as may be held in external data storage XDB. Such external datasets XSD may represent consumer DC's background knowledge, also referred to herein as attacker's background knowledge (“ABK”). Background knowledge may refer to data (including relations, attributes, QIDs, etc) that the data consumer DC may be assumed to be in possession of, and that may be used by data consumer DC in combination with the data set DS′. Using the data table analyzer TAY allows addressing the problem of QIDs. As mentioned earlier, QIDs relate to some attributes/data fields that, on their own, do not allow unique identification of the data subject, as opposed to direct identifiers that do allow such identification. However, plural QIDs, if combined, may still allow data subject identification, even when direct identifiers have been anonymized. If the original dataset DS is not sanitized beforehand, data field anonymizer DAY is preferably operable after the data table anonymizer TAY to safe memory and/or CPU resources.

Describing now the three components in more detail, and referring first back to the privacy model identifier PMI, this may include an analyzer AZ, an attacker/data consumer's background knowledge modeler BKM, and a privacy model selector SL (also referred herein as “the selector SL”).

The analyzer AZ may operate as a dataset explorer to quantify or measure data structure of a given table from set DS. Analyzer AZ may operate per data table Tₖ. It may operate on only a single, but usually on plural data tables, each separately or as a whole, collectively. In particular, in some, but not all embodiments, all data tables in dataset DS may be analyzed by analyzer AZ, Thus, analyzer AZ may operate to describe data structure characteristics of the whole dataset DS. The characteristics of interest may include measurements, such as counts, of data structure and, optionally, statistical results such as earliest and/or latest events/transactions, etc. The measurements (variables) may be used to compute some specific re-identification risks or score, for example, in relation to a shifted date attack, where an attacker, thanks to ABK, can guess and reverse a shift anonymization to leak the original data. Specifically, the measured characteristics may be used to find QIDs for some or each data table in order to apply privacy models such as k-anonymity or others that rely on the QID concept.

The background knowledge modeler BKM may operate to describe the background knowledge of an attacker for the given specific target dataset DS, which may be a multi-relational dataset. The background knowledge modeler BKM may use other data tables T_{k′}, different from the currently processed data table Tₖ, to define the background knowledge. The tables Tₖ may be stored in the same storage DB as the current dataset, or in a related data storage. Optionally, but preferably, the background knowledge modeler BKM may also access the external dataset(s) XDS stored on external storages, such as voter's registries or other public domain information, to so define a more comprehensive knowledge model of the attacker/data consumer DC. The external dataset XDS may not necessarily follow the relational data table model paradigm, so may include unstructured data. If so, the said unstructured data may be transformed by a transformer component (not shown) into data tables for more efficient processing by system SYS.

The selector SL may operate as a privacy model recommender. The selector SL may select, from a storage MEM of privacy models PMⱼ, a target privacy model PMⱼ that fits to the current table Tⱼ. The selection operation by selector SL is based on i) the ABK as defined by background knowledge modeler BKM, possibly (but not necessarily) including the external data XDS, and ii) the measured characteristics of the current and optionally other multi-relational tables as provided by the analyzer AZ. For example, the selected privacy model PMj=mⱼ may be one of k-anonymity.

The data table anonymizer DAY may then operate to apply the model PMj=mⱼ to compute which rows of the current table Tₖ need to be anonymized (such as by suppression), and to apply any one of the above-mentioned anonymization operations to one or more rows of the given (eg, single) data table currently processed. The model PMj may determine at which level the data is to be anonymized, such as at record/row level, or other.

An optional risk collector RC operates to identify high risk data subjects as per the data table anonymizer DAY. High risk data subjects are records whose re-id risk falls below (or, depending on convention, exceeds) an agreed threshold as per the selected privacy model. Thus, the risk collector defines a pool of all the high-risk data subjects identified when applying the privacy model for some or each data table. Such an (explicit) risk collector RC functionality may be optional in some embodiments.

The optional data field anonymizer DAY anonymizes data field(s) within the given multi-relational table Tk, for example based on the identified high risk data subject as identified by risk collector RK, or as identified in pre-defined rule as provided by a data security officer for example.

As mentioned above, the anonymizing operations applied by any one or both of components TAY, DAY may include generalizations, hashing, removing, date shifting, adding noise etc, or other concealing or obfuscating operations. Preferably, generalizations or similar anonymization operations are used to preserve some statistical aspects of the original dataset DS, without allowing unique identification, or with low/acceptable risk (as measured by 1/k probability in k-anonymity) for this to happen.

It will be understood that the inter-relational operation, such timing, coordination of various in- and outputs, etc., of the various components of system SYS described above may be administered by an anonymization controller AC acting as a central coordination logic based on internal states which the anonymization controller AC tracks. Anonymization controller AC may act as a coordinator of the whole anonymization process by linking processing steps and maintaining a log on processing states. However, such a central co-ordination logic is not necessarily required in all embodiments. Thus, the anonymizing controller functionality AC may, if used, not necessarily implemented centrally as shown, but it may itself be implemented in a distributed fashion across multiple computing units or components of system SYS.

The system SYS may process in a similar manner other tables Tk′ of the dataset, such as all such tables, each being anonymized based on their respective privacy model. The privacy model types or instances selected may be different for each data table, or some tables may attract the same privacy model type or instance, depending on the respective data table characteristics as ascertained by analyzer AZ.

As an optional further component, the system SYS may include a user interface UI that allows user to control the type or amount of external data that is to be considered when selecting the privacy model. For example, a graphical user interface or other means may be used where a user can interact with the user interface through selectively designating which data is to be used as background knowledge and/or which additional tables for a given current table is to be considered when computing the respective fitting privacy model. In this way, the user can review to what extent the data is modified as result of changing external knowledge. The more knowledge is allowed to be admitted for consideration, the more severe the anonymization will be, rendering potentially some of the data less useful. Thus, in one embodiment, the user interface explorer UI allows the user to preview how the modified dataset DS' looks like as a function of admitted ABK. Properties, such as number of modified data or other statistical information/aspects may be visualized on a display device (not shown). In embodiments, in response to changes on the amount or type of background data ABK or other additional data admitted, the above-described privacy model selection and anonymization operation may be re-run to produce, in a dynamical manner, different modified datasets DS′ⱼ, each corresponding to different sets j of amount/type of admitted external data (such as background knowledge). The user can thus explore, in preferably real time, how the modified data DS′ⱼ changes over sets j. The user interface may thus assist user in finding a suitable compromise on the amount or type of external data to be considered for privacy model selection.

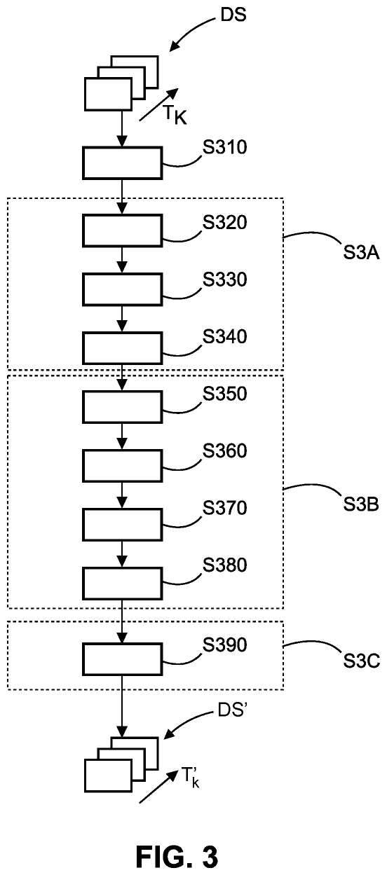

Reference is now made to the flow chart of FIG. 3 which shows steps of a computer-implemented method of anonymizing a dataset, especially a set of the multi-relational type, such as may be held in a relational (such as a multi-relational) database system or other (non-volatile) data storage. It will be understood however that the processing steps described below in respect of the method are not necessarily tied to the architectures described above in FIG. 1 or 2. Thus, the method described below may be understood as a teaching in its own right.

At step S310 an input table Tₖ from an initial dataset DS to be anonymized is received.

At step S3A, the input table is analyzed to determine one or more descriptive quantities that describe the data structure of the table, for example by determining QIDs for the table and/or by measuring other characteristics of the input table.

At step S3B, a privacy model is selected based on the descriptive quantities for the given input table.

At step S3C, the table is anonymized by applying one of more anonymizing operations per record in the table, based on the selected privacy model, and this is preferably done for plural records. In other words, applying the selected privacy model may include applying the anonymization operation at record/row level. Based on the privacy model, individual re-id risk scores, such as probabilities for reidentifying are established, preferably per record in the table. Table(s) whose re-id risk score is below/above a pre-defined threshold are subjected to anonymization operation. Such re-id risk score may be formulated in terms of parameter k of k-anonymity model, or in models derived or related to the k-anonymity model.

In an additional, optional, per data field anonymizing operation, individual data fields are anonymized to remove direct identifier or sensitive information as per pre-defined data controller rules, to so remove such data that may have remained after the application of the per table based, privacy model driven, anonymizing operation.

The above steps S310, S3A-S3C may be repeated for other one or more tables from the original target dataset, such as for all tables. In some cases however, it may not be necessary to process all tables, although this may be preferred in most cases.

The above steps S3A-S3C may be applied locally or globally. When applied locally, only information based on the input table is used. If applied globally, also derived/additional data is included to compute the descriptive information, select the privacy model, apply the anonymizing operations per table or per data field, as required. The additional data may include such information from other tables in the same dataset or information from tables from other external datasets. In particular, such external datasets may represent ABK.

Describing now step S3A in more detail, this may include sub-steps S320-S340.

At step S320 characteristics of target dataset DS are computed, for example in terms of the said descriptive quantities. The characteristics which are expressed by such descriptive quantities may describe the data structure of some or each data table in the target dataset DS. The characteristics may be represented by statistical measurements, such as time span (earliest and latest data points), of a part or the whole of dataset DS. The data structure characteristics may be used for modelling, representing, and/or estimating attacker's background knowledge and/or for privacy model selection. In some embodiments the computing S320 of the said characteristics may include establishing data type, such as numeric, non-numeric, transactional, etc.

Optional step S330, may include computing QIDs for the given table, at least partly based on the descriptive quantities as computed at step S320. The QIDs may be computed and grouped according to data table. The computing of the QIDs for the given table may be based on other tables of dataset DS and/or may be based on ABK as per the external dataset of example. ABK may represents how much background knowledge a data consumer, such as an attacker, may have in relation to the dataset DS. A formal way to express the ABK is via further QIDs as derived from the said external dataset(s). In order to compute appropriate QIDs for the ABK, a profile of the assumed consumer DC may be used, preferably in combination with the characteristics computed at step S320. The profile includes data or information that allows inferring knowledge (relations, etc) that the consumer may be assumed to have. The profile may be modelled statistically.

In embodiments, a special virtual table could be constructed as a mechanism of representing or modelling the ABK. For example, the special virtual table may be based on multiple data tables that an attacker may be assumed to know. For example, the said special virtual table may be merged from such multiple data tables, or may be otherwise combined. Any other way of modelling ABK is also envisaged herein. The virtual table may be created according to data subject ID, and some or all the derived Quasi-Identifiers. Such a virtual data table may be used to identify in particular high-risk data subjects.

At step S340, a privacy model is selected for the given data table, based on the computed characteristics and, optionally, the model for the ABK. The selection step S340 may include a fitting operation. In embodiments, the selection may be based on the QIDs as computed for the table or for the combination of the given table with additional data, such as the ABK or other. The selection of the fitting privacy model may be based mainly on the background knowledge, for example in relation to K^{m}-anonymity. Alternatively, or in addition, the said characteristics of step S320 are used, such as may be the case for a transactional table. The characteristics may be based on a total size of the respective data item converted from transactions.

Other attributes in relation to transactions may also have a bearing on feasibility of applying a particular privacy model for a given data table. For example, the k-anonymity privacy model is suitable for a single relation dataset (microdata), whilst other privacy models (such as k^{m}-anonymity) is more suitable for transactional dataset that holds transactional data rather than relational data. Relational data (eg, single value) tends to remain the same over time, whilst transactional data (eg, set-valued, generated during transactions) is more dynamic, so may change over time.

The privacy model selecting operation S340 may be based on computing a “best fit” model. The descriptive quantities computed at the data structure analyzer step S320 may include a classification of the input table based on the ratio of distinct data subjects versus the total number of rows in the input table. For a ratio within a given margin of l, k-Anonymity model may be appropriate. A ratio that differs from l by more than the margin (eg, 0.9), the k′-anonymity model may be selected, or other similar privacy model. In addition, for k-anonymity related privacy models, a score may be computed for some or each data field/attribute to qualify as a QID. This computing could be based on re-identifiability scores, which includes uniqueness scores and influence scores. Such scores have been described for instance by Yasser Jafer in a master thesis titled “Aggregation and Privacy in Multi-relational Databases”, School of Electrical Engineering and Computer Science Faculty of Engineering, University of Ottawa, available online at https://ruor.uottawa.ca/handle/10393/22695. The QIDs may then allow defining the earlier mentioned equivalence classes, and based on this, the re-id risk as 1/(size of equivalence class) for example.

In general, the privacy models are selected based on the descriptive quantities that describe the data structure of the given individual table in the target dataset DS. Values of suitable such descriptive quantities may be stored versus different privacy models in a look-up-table (LUT) that may be compiled by an expert beforehand. The LUT may then be used to implement selection step S340. One such descriptive quantity may be based as said above on a ratio of the number of distinct data subjects and the total number of records. the descriptive quantity may be then thresholded to implement privacy model selection.

Other privacy model types that may selected herein based on the characteristics (including data type) include any one of: t-closeness, l-diversity, (a, k)-anonymity, m-invariance, (k, e)-anonymity, (ε, m)-anonymity, multi-relational k-anonymity, δ-disclosure privacy, or others still.

The t-closeness privacy model is an extension of k-anonymity, and may be selected when dealing with sensitive attributes and where consideration of semantic level closeness is required.

The l-diversity privacy model, is an extension of k-anonymity, and may be selected when dealing with sensitive attributes, but without consideration of semantic level closeness.

The (a, k)-anonymity privacy model is an enhanced version of k-anonymity, and may be selected when dealing with sensitive attributes.

The m-invariance privacy model, based on of k-anonymity, may be selected if second or subsequent releases of the dataset is intended, and inference re-id risk needs to be considered between multiple releases.

The (k, e)-anonymity privacy model is an alteration of k-anonymity, and may be selected when dealing with sensitive attributes of the numeric type.

The (ε, m)-anonymity privacy model is a refinement to the (k, e)-anonymity privacy model, and may be selected to overcome a proximity breach. This model may be selected for sensitive attributes of the numeric type.

The δ-disclosure privacy model is a more restrictive version of t-closeness. This privacy model may be selected if a strong re-id risk (quantified by a suitable metric/threshold, etc.) needs to be considered.

Describing now step S3B in more detail, this may include sub-steps S350-S380.

At an optional step S350, one more anatomization operations are initiated. At optional step S360 high risk data subjects are reported, such as to a risk collector or other tallying or tracker facility. The reporting may be done according to the risk threshold as defined by the privacy model and as computed in step S340.

The reported high risk data subjects are retrieved in step S370.

At step S380, the anonymization operation is applied per data table based on the selected privacy model and the retrieved high-risk subjects as per step S370. This step may include iterating through other data tables. The anonymization operation, such as row suppression, makes the respective data inaccessible to data consumer.

Row(s) for the high-risk data subjects so retrieved may be suppressed also in other data tables (other than the current data table) in step S380. Thus, the anonymization operation may be extended from the target data table to other tables in the dataset. For example, rows from other tables may be anonymized (such as suppressed) according to the captured high-risk data subjects in the target (current) data table.

Steps S350-S380 ensure that no tables will contain any data related to any high-risk data subject identified.

The high-risk data reporting and retrieving S360, S370 may be done for each table separately. Preferably however, the high-risk data subject reporting is performed across plural tables, preferably all data tables. The advantage is that if a subject/record is identified as high risk in one table, some, preferably all, related data across some, preferably all, other tables are also subjected to anonymization operation. That is, the anonymizing operation is carried out across plural, if not all, tables. The said related data may include records of high-risk data subjects captured in other tables.

Describing now step S3C in more detail, this may include step S390 of anonymizing certain data fields individually, as opposed to the per table/row-wise processing of step S380. Step S390 may be based on pre-defined rules as prepared by a data privacy officer for example. The rules define which kind of information should be made inaccessible, in case the above step S380 did not make this information already inaccessible. The pre-defined rules may be created based on the selected privacy model at step S340. The pre-defined rules could be generated in a semi-automatic way. The pre-defined rules may be based on data type, such as date/time, free text, numeric, etc.

The step of anonymizing the data fields may be optional, in particular if the data fields have been already anonymized previously.

The anonymized data set DS's or parts thereof may be made available to data consumer DC for processing, such as training a machine learning model, preferably for medical applications, data analytics, or other data consuming tasks for facilitating medical practice, etc.

The method may be used in data transfer, such as when transferring data from one cloud node to anther cloud node, or when uploading data into a cloud node. Such transferring may also be referred to as data release. However, such release may not necessarily entail complete transfer to data consumer. For example, such release may merely entail that data consumer DC is granted remote access to the anonymizer set DS′, such as through queries.

The components of the system SYS may be implemented as one or more software modules, run on one or more general-purpose processing units PU, such as a desktop computer, laptop, one or more server computers, a smart phone, tablet, etc.

Alternatively, some or all components of system SYS may be arranged in hardware such as a suitably programmed microcontroller or microprocessor, such an FPGA (field-programmable-gate-array) or as a hardwired IC chip, an application specific integrated circuitry (ASIC).

In a further embodiment still, the system SYS may be implemented in both, partly in software and partly in hardware.

The different components of system SYS may be implemented on a single data processing unit PU. Alternatively, some or more components are implemented on different processing units PU, possibly remotely arranged in a distributed architecture and connectable in a suitable communication network such as in a cloud setting or client-server setup, etc.

One or more features described herein can be configured or implemented as or with circuitry encoded within a computer-readable medium, and/or combinations thereof. Circuitry may include discrete and/or integrated circuitry, a system-on-a-chip (SOC), and combinations thereof, a machine, a computer system, a processor and memory, a computer program.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above-described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfill the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium (in particular, but not necessarily, a non-transitory medium), such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope. Reference signs envisaged herein include numbers, strings of letters, or combinations thereof.

1. A system for anonymizing a multi-relational dataset, comprising:
an input interface configured to receive at least one data table of the multi-relational dataset;
an analyzer configured to analyze the at least one data table to obtain a result describing one or more characteristics of the at least one data table;
a selector configured to select, based on the result, a privacy model for the at least one data table from plural privacy models; and
an anonymizer configured to apply a first anonymizing operation to the at least one data table based on the selected privacy model to obtain at least one anonymized data table.

2. The system of claim 1, wherein the input interface is further configured to receive additional data, and the analyzer is further configured to analyze the additional data to obtain the result.

3. The system of claim 2, wherein the additional data includes external data associated with the at least one data table, wherein the external data is external to the dataset, and is representative of a data consumer's background knowledge; and
the analyzer is further configured to analyze the external data to obtain information that describe background knowledge of the at least one data consumer for the at least one data table, the result being based on the information and the least one data table.

4. The system of claim 3, wherein the analyzer is further configured to analyze at least one data consumer's profile to obtain the information that describe the background knowledge of the at least one data consumer for the at least one data table.

5. The system of claim 2 comprising a user interface configured to allow a user to vary type and/or amount of the additional data, the analyzer, in response to such variation providing different results thus causing the system to provide different versions of the at least one anonymized data table.

6. The system of claim 2, wherein the information includes one or more other data tables from the dataset, the analyzer to further analyze the said one or more other data tables to obtain the result.

7. The system of claim 1, wherein the anonymizer is further configured to apply a second anonymizing operation to one or more data fields of the at least one anonymized data table, based on a pre-defined set of data-field level anonymization rules.

8. The system of claim 1, wherein the first anonymizing operation is configurable to act on plural records of the at least one data table.

9. The system of claim 1, wherein the first anonymizing operation is configurable to make a record of the at least one data table inaccessible to a dataset query, and/or wherein the second anonymizing operation is configurable to make a data-field of the at least one data table inaccessible to a dataset query.

10. The system of claim 3, wherein the said information includes one or more statistical descriptors.

11. The system of claim 10, wherein the one or more statistical descriptors include one or more quasi-identifiers of the at least one data table.

12. The system of claim 6, wherein plural data tables are anonymized based on their respective privacy model.

13. The system of claim 1, where the plural privacy models are retrieved by the selector from a storage.

14. A method for anonymizing a multi-relational dataset, comprising:
receiving at least one data table of the multi-relational dataset;
analyzing the at least one data table to obtain a result describing one or more characteristics of the at least one data table;
selecting, based on the result, a privacy model for the at least one data table from plural privacy models; and
applying a first anonymizing operation to the at least one data table based on the selected privacy model to obtain at least one anonymized data table.

15. A computer program product comprising a non-transitory computer readable medium, the non-transitory computer readable medium having computer readable code embodied therein, the computer readable code being configured such that, on execution by a processor, the processor is caused to perform the method as claimed in claim 14.

16. The method of claim 14, further comprising: receiving additional data and analyzing the additional data to obtain the result.

17. The method of claim 16, wherein the additional data includes external data associated with the at least one data table, wherein the external data is external to the dataset, and is representative of a data consumer's background knowledge; and wherein the method further comprises analyzing the external data to obtain information that describe background knowledge of the at least one data consumer for the at least one data table, the result being based on the information and the least one data table.

18. The method of claim 17, further comprising analyzing at least one data consumer's profile to obtain the information that describe the background knowledge of the at least one data consumer for the at least one data table.

19. The method of claim 16, further comprising allowing a user to vary type and/or amount of the additional data and, in response to such variation, providing different versions of the at least one anonymized data table.

20. The method of claim 16, wherein the information includes one or more other data tables from the dataset, the analyzer to further analyze the said one or more other data tables to obtain the result.
